(19) United States
(12) Patent Application Publication
(10) Pub. No.: US 2008/0185389 A1
(43) Pub. Date: Aug. 7, 2008

(54) VACUUM STORAGE BOX

(75) Inventor: Yiming ZHAO, Beijing (CN)

Correspondence Address: SHERIDAN ROSS PC, 1560 BROADWAY, SUITE 1200, DENVER, CO, 80202, US

(73) Assignee: BEIJING BOE OPTOELECTRONICS TECHNOLOGY CO., LTD., Beijing (CN)

(21) Appl. No.: 11/956,885

(22) Filed: Dec. 14, 2007

(30) Foreign Application Priority Data
Feb. 6, 2007 (CN) 200720103483.3

(51) Int. Cl. A47J 41/02

(52) U.S. Cl. 220/592.27

(57) ABSTRACT

Provided is a vacuum storage box. The vacuum storage box comprises a body and an exhaust valve and a communication valve that are provided on the body. The exhaust valve is used for connecting with a vacuum pump, and the communication valve is used to balance pressure inside and outside the body. The vacuum storage box can be used to preserve a polarizer sheet, COF or TCP therein.

### BACKGROUND OF THE INVENTION

The present invention relates to a vacuum storage means, and particularly, to a vacuum storage box for preserving a polarizer sheet, chip on film (COF) or tape carrier package (TCP).

Under normal conditions, moisture in the air is easily absorbed on the PVA layer of a polarizer sheet used for a liquid crystal panel, which renders the storage life of the polarizer sheet limited to six days only after unsealing. If the polarizer sheet that have been stored for long time are used, poor attachment, bubbling and so on will happen in manufacturing process, causing degradation of product quality. If a COP or a TCP is stored under normal conditions, the electrodes of the COP or TCP are prone to be oxidized because of the moisture and dusts in the air. If the electrodes are short-circuited by a dust or foreign particle, the electrodes will not function properly in manufacturing process.

The above problems are not solved well in the field. The unsealed COF, TCP or polarizer sheet has to be used as soon as possible, otherwise may be discarded after a long storage period, resulting in waste and increased manufacturing cost.

### SUMMARY OF THE INVENTION

In view of the above problem, there are needs for an apparatus for preserving a polarizer sheet, COF or TCP, which can efficiently lengthen the storage life of the polarizer sheet, COF or TCP after unsealing.

The embodiments of the present invention provide a vacuum storage box comprising a body and an exhaust valve and a communication valve that are provided on the body. The exhaust valve is used for connecting with a vacuum pump, and the communication valve is used to balance pressure inside and outside the body. The vacuum storage box can be used to preserve a polarizer sheet, COF or TCP therein.

Preferably, the vacuum storage box further comprises a vacuum pressure meter provided on the body.

Preferably, at lease one of inner surfaces of the body may be provided with a soft material, such as polyvinyl chloride (PVC), polyurethane (PU), and the like.

With cooperation between the exhaust valve and the communication valve, the vacuum storage box according to the present invention can be used to reliably preserve a material such as a polarizer sheet, COF or TCP and extend the storage life of the material, thereby increasing the life of the material, eliminating waste and decreasing manufacturing cost. Also, with the vacuum storage box, the operation such as placing in and taking out can be easily performed in manufacturing.

The vacuum storage box according to the present invention can be further widely applied to preserve materials in the fields of plasma display panel (PDP), twisted nematic LCD (TN-LCD), super twisted nematic LCD (STN-LCD), thin film transistor LCD (TFT-LCD) and so on in manufacturing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematically structural view of the vacuum storage box according to the present invention.

### DETAILED DESCRIPTION OF THE PREFERRED EMBODIMENTS

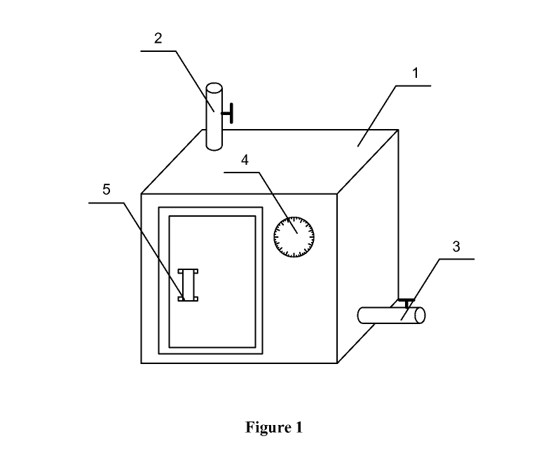

FIG. 1 is a schematically structural view of the vacuum storage box according to the present invention. As shown in FIG. 1, in the present invention, the vacuum storage box is used for preserving, for example, a polarizer sheet, COF and TCP, and comprises a body 1, an exhaust valve 2 and a communication valve 3 provided on the body 1. The body 1 is configured to preserve the polarizer sheet, COF and TCP therein in a vacuum condition. A vacuum pump can be connected to the exhaust valve 2 so as to exhaust the air within the body 1 and produce a vacuum in the body 1 for preservation.

When items such as polarizer sheets are preserved in the box and a vacuum is produced through vacuum pumping, the exhaust valve 2 is closed. The communication valve 3 functions to balance the pressure inside and outside the body 1. Specifically, during vacuum pumping and preserving in vacuum, the communication valve 3 is closed; and when the preserved items are to be taken out of the box, the communication valve 3 is opened first to communicate inside and outside of the body 1, and the polarizer sheet, COF or TCP preserved in the body can be taken out after the pressure inside and outside the body has been balanced. The configuration of the vacuum storage box according to the present invention facilitates preserving and taking-out of the items.

Further, a door 5 is provided on the body 1 through which the items can be placed into or taken out of the body 1. A vacuum pressure meter 4 can be provided on the body 1 and employed to show the pressure inside the body 1 so as to determine when to close or open the valves 2 and 3. Moreover, a soft material layer can be preferably applied on at lease of the inner surfaces of the chamber of the body 1, and the soft material can prevent the preserved items therein from being scraped and enhances the preservation quality. The body 1 and the door 5 can be fabricated according to the size and quantity of the items to be preserved, so as to meet the requirement of preserving products of various types.

If preserved with the vacuum storage box according to the present invention, the storage life of the polarizer sheet can be increased to about 25˜30 days, which is greatly extended compared with the storage life of 3˜6 days under the normal conditions, thereby increasing the life of the polarizer sheet. Also, if preserved with the vacuum storage box according to the present invention, COF or TCP can be preserved more than three months after unsealing, much longer than the preservation period of 30 days under the normal conditions. Therefore, waste of raw materials can be eliminated and manufacturing cost can be decreased.

Furthermore, the vacuum storage box according to the present invention can be widely employed to preserve other materials in the fields of PDP, TN-LCD, STN-LCD, TFT-LCD and so on in manufacturing.

The invention being thus described, it will be obvious that the same may be varied in many ways. Such variations are not to be regarded as a departure from the spirit and scope of the invention, and all such modifications as would be obvious to those skilled in the art are intended to be comprised within the scope of the following claims.

What is claimed is:

1. A vacuum storage box, comprising
a body, and
an exhaust valve and a communication valve that are provided on the body,
wherein the exhaust valve is used for connecting with a vacuum pump, and the communication valve is used to balance pressure inside and outside the body.

2. The vacuum storage box of claim 1, further comprising a vacuum pressure meter provided on the body.

3. The vacuum storage box of claim 1, wherein at lease one of inner surfaces of the body is provided with a soft material.
